(19) United States
(12) Patent Application Publication
(10) Pub. No.: US 2020/0142101 A1
(43) Pub. Date: May 7, 2020

(54) HALF MIRROR PANEL AND HALF MIRROR DEVICE HAVING THE SAME

(71) Applicants: Hyundai Motor Company, Seoul (KR); Kia Motors Corporation, Seoul (KR); Three Nine Co., Ltd, Ansan (KR)

(72) Inventors: So Jung Shim, Seoul (KR); Seung Chan Hong, Anseong (KR); Byung Sam Kim, Ansan (KR); Jae Kyung Chun, Siheung (KR)

(21) Appl. No.: 16/560,509

(22) Filed: Sep. 4, 2019

(30) Foreign Application Priority Data
Nov. 2, 2018 (KR) 10-2018-0133327

(51) Int. Cl. G02B 1/14; G02B 5/08; B60R 13/02; B60Q 3/60

(52) U.S. Cl. CPC G02B 1/14; B60Q 3/60; B60R 13/02; G02B 5/0808

(57) ABSTRACT

A half mirror device includes a panel, and at least one light source disposed on a back side of the panel to emit light. The panel includes a light-transmitting base layer, a mirror layer formed on a front surface of the base layer to reflect light, the mirror layer having a plurality of light-transmitting holes at regular intervals through opposite surfaces of the mirror layer in a thickness direction, and a light-transmitting protective layer formed on a front surface of the mirror layer to protect the mirror layer, wherein the light source transmits light through the light-transmitting holes of the mirror layer.

### CROSS REFERENCE TO RELATED APPLICATION(S)

This application claims under 35 U.S.C. § 119(a) the benefit of Korean Patent Application No. 10-2018-0133327, filed on Nov. 2, 2018, the entire contents of which are incorporated by reference herein.

### BACKGROUND

### (a) Technical Field

The present disclosure relates generally to a half mirror panel and a half mirror device including the half mirror panel, and more particularly, to the half mirror panel for implementing a lighting effect of a half mirror, which serves as both a mirror and a light when a light source is turned off/on, respectively.

### (b) Description of the Related Art

An interior of a vehicle is a space configured to be occupied by a driver and passenger(s), so it is equipped with various components for improving driving efficiency and safety of the driver and passenger(s). The interior typically is designed for aesthetic appearance, as well as function.

Generally, a dashboard is provided on a front side of the interior of a vehicle at a boundary with an engine compartment. Conventionally, instrumentation and switches for the vehicle's operation and the driver/occupant(s)'s convenience are located at proper positions on the dashboard.

Recently, improvements in the design of the dashboard have been proposed to improve the aesthetic appearance of the interior of the vehicle. For example, a mirror effect or lighting effect in a specified lighting pattern may be implemented to the dashboard.

A representative technique to simultaneously implement such mirror and lighting effects is a half mirror technique.

Generally, a half mirror is an object that is equipped with a light source of desired light colors on a back surface thereof so as to reflect a portion of light and transmit a portion of light. Thus, when the light source is turned on/off, the half mirror has the light effect/mirror effect, respectively. The half mirror is coated with reflective coatings such as metallic coatings, optical film coatings, etc. for the implementation of the mirror effect, using various kinds of surface treatment methods. However, with such surface treatment methods, an object is transmitted or not transmitted with light over an entire area thereof.

To solve this problem, a recent modification to a half mirror includes holes in a specified pattern that are formed in a metallic coating or an optical film to reflect light to allow the light to only transmit the holes of the specified pattern. However, this solution has a problem in that the holes in the specified pattern are distinctly viewed, degrading the aesthetic appearance.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure proposes a half mirror panel in which, when a light source is turned off, an entire area of the half mirror panel has a mirror effect, and when the light source is turned on, a transmitting area of the half mirror panel has a lighting effect, and a remaining non-transmitting area of the panel still has the mirror effect.

According to one aspect of the present disclosure, there is provided a half mirror panel including: a light-transmitting base layer; a mirror layer formed on a front surface of the base layer to reflect light, the mirror layer having a plurality of light-transmitting holes at regular intervals through opposite surfaces of the mirror layer in a thickness direction; and a light-transmitting protective layer formed on a front surface of the mirror layer to protect the mirror layer.

The mirror layer preferably may have a thickness of greater than or equal to 100 nm.

The mirror layer preferably may have a thickness of less than or equal to 15 μm.

The light-transmitting hole of the mirror layer may preferably have a diameter of 30 μm to 150 μm.

The diameter of the light-transmitting hole preferably may be 55 μm to 80 μm.

The light-transmitting hole of the mirror preferably may pass through the mirror layer from a back surface to the front surface of the mirror layer in a linear form.

The light-transmitting holes of the mirror layer may be spaced apart at equidistant intervals.

The light-transmitting holes of the mirror layer preferably may be spaced apart from each other at intervals of 100 μm to 400 μm.

The light-transmitting holes of the mirror layer preferably may be spaced apart from each other at intervals of 150 μm.

The light-transmitting holes of the mirror layer may be spaced apart at regularly-increasing or decreasing intervals in a first direction, and at equidistant intervals in a second direction perpendicular to the first direction.

The front surface of the mirror layer may be divided into a transmitting area and a non-transmitting area, wherein the light-transmitting holes are formed in the transmitting area.

The base layer preferably may have a thickness of greater than or equal to 10 μm.

The protective layer preferably may have a thickness of greater than or equal to 15 μm.

According to another aspect of the present disclosure, there is provided a half mirror device including: a panel; and at least one light source disposed on a back side of the panel to emit light, the panel including: a light-transmitting base layer; a mirror layer formed on a front surface of the base layer to reflect light, the mirror layer having a plurality of light-transmitting holes at regular intervals through opposite surfaces of the mirror layer in a thickness direction; and a light-transmitting protective layer formed on a front surface of the mirror layer to protect the mirror layer, wherein the light source transmits light through the light-transmitting holes of the mirror layer.

A front surface of the panel may be divided into a transmitting area and a non-transmitting area, wherein the light-transmitting holes of the mirror layer are formed in the transmitting area, and the light source is disposed on a back side of the transmitting area.

According to the embodiments of the present disclosure, fine light-transmitting holes are formed in the panel having the mirror effect at regular intervals, thereby obtaining the effects where, when the light source is turned off, the entire area of the panel has the mirror effect, and when the light source is turned on so that light transmits through the light-transmitting holes in the transmitting area of the panel, the transmitting area of the panel has the lighting effect, and the remaining non-transmitting area of the panel still has the mirror effect.

Further, after the non-transmitting mirror layer is formed on the entire area of the panel, the light-transmitting holes can be controllably formed in the transmitting area using a laser etching method, thereby having the effect of preventing a leakage of light through a connection with peripheral parts.

### BRIEF DESCRIPTION OF THE DRAWINGS

The above and other objects, features and advantages of the present disclosure will be more clearly understood from the following detailed description when taken in conjunction with the accompanying drawings, in which:

FIG. 1 is a cross-sectional view illustrating a half mirror device according to an embodiment of the present disclosure;

FIG. 2 is a plan view illustrating the half mirror device of FIG. 1;

FIG. 3 is a plan view illustrating a half mirror device according to another embodiment of the present disclosure;

FIG. 4 is a view illustrating a procedure of manufacturing the half mirror device;

FIG. 5 is a photograph illustrating lighting states of the half mirror device according to examples and comparative examples; and

FIG. 6 is a photograph illustrating lighting effects of the half mirror device according to an example and a comparative example.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinbelow, preferred embodiments of the present disclosure will be described in detail with reference to the accompanying drawings. The present disclosure, however, is not limited to embodiments disclosed below, but may be implemented in a variety of forms. The embodiments of the present disclosure are merely provided to allow the present disclosure to be completed and thus an ordinary skilled person to fully understand the scope of the disclosure. Like reference numbers indicate like elements throughout the drawings.

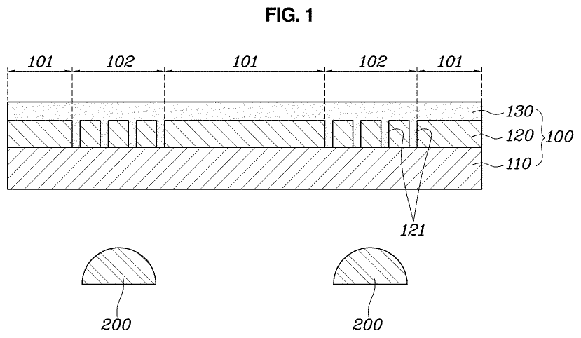

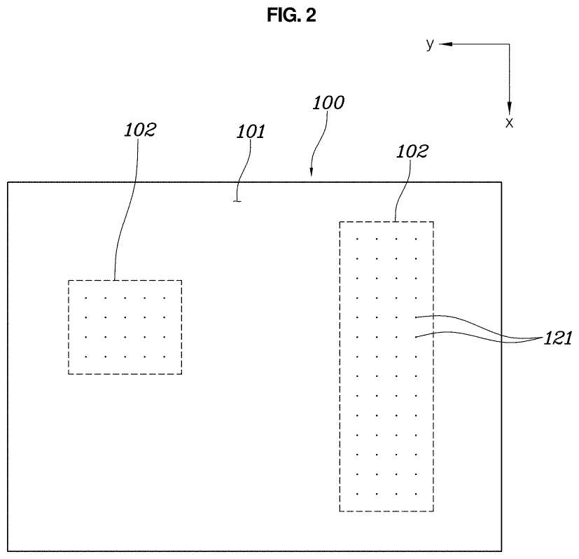

FIG. 1 is a cross-sectional view illustrating a half mirror device according to an embodiment of the present disclosure, and FIG. 2 is a plan view illustrating the half mirror device of FIG. 1.

As shown in FIGS. 1-2, the half mirror device preferably is a hidden-type half mirror light in which, when a light source 200 is turned off, an entire area of the half mirror device has a mirror effect, and when the light source 200 is turned on, a predefined area has a lighting effect, without being distinctly discerned from a remaining area even when the light source 200 is turned off, thereby providing a suitable aesthetic appearance. To this end, the half mirror device includes a panel 100 divided into a non-transmitting area 101 and a transmitting area 102, and at least one light source (e.g., the light source 200) disposed on a back side of the panel 100 to emit light onto the panel 100.

The panel 100 includes a base layer 110, a mirror layer 120, and a protective layer 130, which are sequentially stacked on one another. The layers are stacked in a direction from the back side toward the front side of the panel 100. The back side of the panel 100 denotes a direction in which the light source 200 is disposed, and the direction from the back side towards the front side of the panel 100 denotes a direction toward which light is emitted when the light source 200 is turned on.

The base layer 110 is a light-transmitting layer which forms the entire shape of the panel 100 as a base for forming the mirror layer 120 thereon. The material of the base layer is not particularly limited to a specified material. For example, the base layer 110 may be formed of polycarbonate (PC), polymethyl methacrylate (PMMA), polyethylene terephthalate (PET), polyethylene terephthalate glycol-modified (PETG), acrylic resins, etc. Further, the base layer 110 may include a light-diffusing agent, a quencher, etc. Thus, the base layer 110 is formed to be transparent when not containing the quencher, and is formed to be translucent when the quencher is contained.

In addition, if the base layer 110 transmits light and provides a base on which the mirror layer 120 is formed, a thickness of the base layer 110 is not limited to specific value, but is preferably greater than or equal to 10 μm. If the thickness of the base layer 110 is less than 10 μm, defects may occur due to incorporation of impurities. In addition, if the base layer 110 can coat, the upper limit of the thickness of the base layer 110 is not limited to specific value, but is preferably less than or equal to 100 μm.

The mirror layer 120 is a reflective layer which is formed on a front surface of the base layer 110 to reflect light, having the mirror effect. The mirror layer 120 has non-transmittance in opposite directions.

To allow light-transmittance to have the lighting effect, the mirror layer 120 is provided with a plurality of light-transmitting holes passing through the mirror layer 120 in a thickness direction, i.e., the direction from the back surface towards the front surface thereof, in a linear form at regular intervals. Particularly, the light-transmitting holes 121 pass through the mirror layer 120 preferably in the linear form in the direction from the back surface towards the front surface of the mirror layer 120 to transmit light therethrough. Here, the light-transmitting holes of the mirror layer 120 preferably may be spaced apart at regular intervals only in the transmitting area of the panel. Thus, when the light source 200 is turned on, the light from the light source is transmitted through the light-transmitting holes 121, so that the transmitting area 102 has the lighting effect and the non-transmitting area 101 has the mirror effect, because the light is prevented from being transmitted therethrough by the mirror layer 120.

The length of the light-transmitting hole 121 extending in the linear form in the thickness direction from the back surface towards the front surface of the mirror layer 120 is not limited to a shortest length between the back surface and the front surface of the mirror layer 120. For example, although the light-transmitting holes 121 are preferably provided in the shortest length in a vertical direction between the back surface and the front surface of the mirror layer 120 as shown in FIG. 1, the present disclosure is not limited thereto, but the light-transmitting holes 121 may be provided in an inclined form between the back surface and the front surface of the mirror layer 120. The light-transmitting holes 121 preferably have a regular arrangement at the front surface of the mirror layer 120.

The remaining area other than the light-transmitting holes 121 of the mirror layer 120 should be the non-transmitting area to prevent the transmission of light. Thus, the mirror layer 120 preferably may have a metallic coating or a coating of a chemical compound containing a metal with a predefined thickness or more to prevent the transmission of light. For example, it is preferred that the mirror layer 120 be formed of a material selected from the group consisting of Al, AlN, Cr, CrN, Ni, NiCr, Ag, Ge, In, Sn, Ti, TiN, TiCN, Si, SiN, or compounds thereof. In addition, the mirror layer 120 may be formed as a single layer of any one of the above-mentioned materials, but may be formed as multilayer of the above-mentioned materials. Further, the mirror layer 120 may be an optical film (deposition using TiO₂, SiO₂, Al₂O₃, etc.) containing any one of the above-mentioned materials.

The mirror layer 120 preferably has a thickness of greater than or equal to 100 nm. If the thickness of the mirror layer 120 is less than 100 nm, the thickness is too thin to transmit light through the metallic coating. And The mirror layer 120 preferably has a thickness of less than or equal to 15 μm. If the thickness of the mirror layer 120 is greater than 15 μm, there is a possibility that the periphery of the light-transmitting holes 121 may be broken when the light-transmitting holes 121 is formed.

The mirror layer 120 may be formed by means of plating such as vacuum deposition including CVD, PVD (sputtering, evaporation, etc.), or wet plating.

Although the light-transmitting holes 121 of the mirror layer 120 have the transmittance of light from the light source 200, it is preferred that the light-transmitting holes 121 are not discerned from the other area when the light source 200 is turned off, the light-transmitting holes 121 are formed in a hidden type in order to improve the aesthetic appearance. Thus, the light-transmitting holes 121 preferably may have a diameter of 150 μm or less. However, if the diameter of the light-transmitting hole 121 is too small, the light from the light source 200 is not transmitted therethrough, the diameter of the light-transmitting hole 121 preferably is greater than or equal to 30 μm. More preferably, the diameter of the light-transmitting hole 121 is 55 μm to 80 μm to maintain an excellent aesthetic appearance of the mirror layer 120 and transmit light effectively. More preferably, it is effective that the diameter of the light-transmitting hole 121 is 55 μm to 75 μm.

The light-transmitting holes 121 preferably may be spaced apart at regular intervals in order to distribute homogeneous lighting during the lighting effect of the light-transmitting hole. For example, as shown in FIG. 2, the light-transmitting holes 121 are all provided at equidistant intervals in the transmitting area, thereby having the homogeneous lighting effect over the entire transmitting area 102.

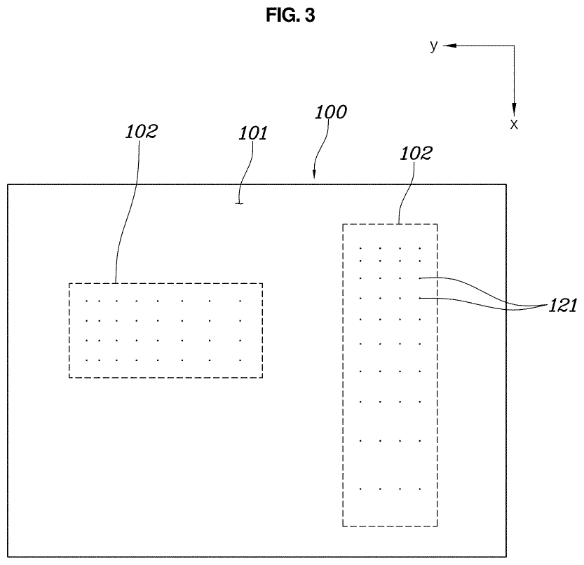

The light-transmitting holes 121 are preferably spaced apart from each other at intervals of 100 μm to 400 μm. When the interval between adjacent light-transmitting holes 121 is less than 100 μm, the intervals of the light-transmitting holes 121 with respect to the diameter thereof are too narrow such that a mirror effect is not implemented. On the contrary, when the interval between the adjacent light-transmitting holes 121 exceeds 400 μm, the intervals between the adjacent light-transmitting holes 121 are too wide. Accordingly, when the light source 200 is turned on, the interval between lights passing and transmitted through the light-transmitting holes 121 is too wide, whereby the aesthetic lighting effect is degraded. More preferably, the light-transmitting holes 121 are spaced apart from each other at intervals of 150 μm to 300 μm to maintain an excellent aesthetic appearance of the mirror layer 120 and the lighting effect Specifically, the light-transmitting holes 121 are preferably spaced apart from each other at intervals of 150 μm. FIG. 3 is a plan view illustrating a half mirror device according to another embodiment of the present disclosure. In this embodiment, for the gradation effect in the lighting in the transmitting area 102, the light-transmitting holes 121 of the mirror layer 120 may be provided at regularly-increasing or decreasing intervals in a first direction and at equidistant intervals in a second direction perpendicular to the first direction. For example, in the left side transmitting area 102 in FIG. 3, the light-transmitting holes 121 has equidistant intervals in an x-direction, and regularly-increasing intervals in a y-direction from the left side to the right side, thereby being dimmed down from the left side to the right side. In addition, in the right side transmitting area 102 in FIG. 3, the light-transmitting holes 121 has equidistant intervals in the y-direction, and regularly-increasing intervals in the x-direction from the upper side to the lower side, thereby being dimmed down from the upper side to the lower side.

The protective layer 130 is a light-transmitting layer which is formed on a front surface of the mirror layer 120 to protect the mirror layer 120. In order to obtain the protection of the mirror layer 120 and a similar appearance to the neighboring parts, the protective layer may be implemented as a transparent or semi-transparent layer. For example, the protective layer 130 may be implemented as a light-transmitting polymer layer. Further, the protective layer 130 may include a light-diffusing agent, a quencher, etc. Thus, the protective layer 130 is formed to be transparent when not containing the quencher, and is formed to be translucent when the quencher is contained.

The thickness thereof is not limited to a specific thickness if the protective layer 130 can protect the mirror layer 120 while transmitting light, but is preferably greater than or equal to 15 μm. If the thickness of the protective layer 130 is less than 15 defects may occur due to incorporation of impurities. In addition, if the protective layer 130 can coat, the upper limit of the thickness of the protective layer 130 is not limited to specific value, but is preferably less than or equal to 100 μm.

The light source 200 is a unit which is disposed on or over the back side of the panel 100 to emit light through the light-transmitting holes 121. The light source 200 may include a variety of light-emitting units. For example, the light source 200 may be an LED, an OLED, or the like, which emits light of various colors. The light source 200 may have at least one light source depending on an area and number of the transmitting regions. The light source 200 is preferably disposed on the back side of the transmitting area 102 of the panel 100.

A method of manufacturing the half mirror device will now be described.

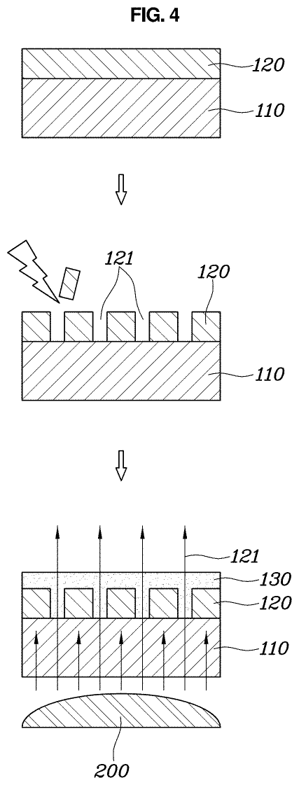

FIG. 4 is a view illustrating a procedure of manufacturing the half mirror device.

As illustrated in FIG. 4, a base layer is injection-molded using a light-transparent material. Here, the base layer may be formed of polycarbonate (PC).

A non-transmitting mirror layer 120 is formed on a front surface of the base layer 110 so as to have the mirror effect.

The mirror layer 120 may be coated with Cr in a thickness of greater than or equal to 100 nm. The mirror layer 120 may be formed by a method selected from PVD, PECVD, and the like, which can coat Cr in a desired thickness.

When the mirror layer 120 is formed on the entire front surface of the base layer 110, a plurality of fine light-transmitting holes 121 is formed in the transmitting area 102 using a laser etching method.

The light-transmitting holes 121 are provided to only pass through the mirror layer 120 under the control of target area and output of a laser. A diameter of the light-transmitting hole 121 may have a range between 30 μm˜150 μm. which is not easily visible, but allows light-transmission. Preferably, intervals between the light-transmitting holes 121 are provided to have a regular relationship among them.

After the light-transmitting holes 121 are formed in the transmitting area of the mirror layer 120, a protective layer 130 is formed on a front surface of the mirror layer 120.

The protective layer 130 is a light-transmitting layer which is formed on the entire front surface of the mirror layer 120 to protect the mirror layer 120. The material of the protective layer 130 may fill the light-transmitting holes 121.

After the base layer 110, the mirror layer 120 having the light-transmitting holes 121, and the protective layer 130 are provided to form the panel 100, a light source 200 is disposed on a back side of the panel 100, preferably in a region corresponding to the transmitting area 102 on the back side of the panel 100.

As such, in the configuration of the half mirror device, when the light source is turned off, the mirror effect is provided by the mirror layer 120 on the front side of the panel. As a result, since it is difficult to visually discern the light-transmitting holes 121 of the mirror layer 120, the aesthetic appearance of the panel is improved.

In the meantime, since, when the light source 200 is turned on, light emitted from the back side of the panel 100 is emitted towards the front side of the panel 100 through the light-transmitting holes 121, the transmitting area 102 has the lighting effect in a pattern corresponding to that of the light-transmitting holes 121. Since the light from the light source 200 is not transmitted through the non-transmitting area 101, in which the light-transmitting holes 121 are not formed, the front side of the panel 100 has the mirror effect by the mirror layer 120.

Appearance and light transmittance of the panel were compared depending on diameters of the light-transmitting hole.

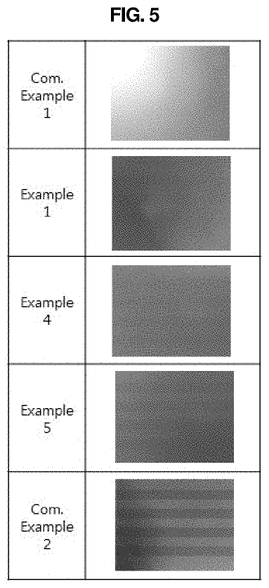

A discernable rate and light transmittance of the light-transmitting hole are indicated in Table 1, and photographs of the appearance of respective examples and comparative examples are shown in FIG. 5.

TABLE 1

| | Comparative | | | | | | Comparative |
|---|---|---|---|---|---|---|---|
| | Example 1 | Example 1 | Example 2 | Example 3 | Example 4 | Example 5 | Example 2 |
| Diameter | 20 μm | 30 μm | 55 μm | 75 μm | 80 μm | 150 μm | 160 μm |
| Discernable | X | X | X | X | Low | Medium | High |
| Rate | | | | | | | |
| Light | 0.5% | 5% | 10% | 14% | 16% | 30% | 38% |
| transmittance | | | | | | | |

As shown in Table 1 and FIG. 5, in Corn. Example 1, although the light-transmitting holes were not visually discernable, the light transmittance was too small to serve as a light. In addition, in Corn. Example 2, although the light transmittance was high, the light-transmitting holes were highly visually discernable, degrading the aesthetic appearance.

On the contrary, in Examples 1 to 5, the light-transmitting holes were not substantially discernable by naked eye and the light transmittance was maintained to 5˜30%, thereby possible having the lighting effect while maintaining a good aesthetic appearance.

Next, lighting effects were compared between Corn. Example 3 in which the light-transmitting holes have a random arrangement, and Example 6 in which the light-transmitting holes have a regular arrangement.

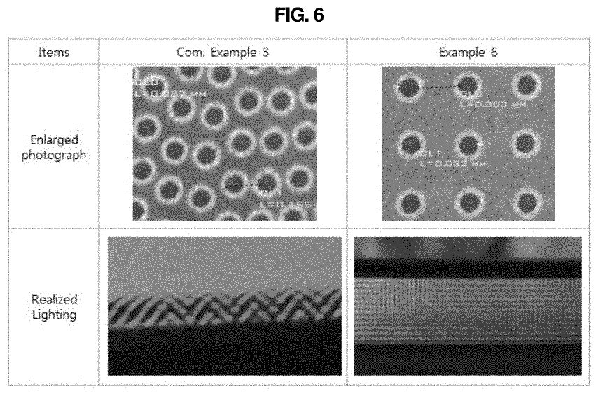

In Com. Example 3 and Example 6, the light-transmitting holes were formed such that they have a diameter of about 80 μm as in FIG. 6, and that Corn. Example 3 has a random interval, and Example 6 has a lattice-type regular pattern with a regular interval of about 300 μm.

FIG. 6 shows the lighting effects of Corn. Example 3 and Example 6, which are viewed on the front side of the half mirror devices of Corn. Example 3 and Example 6 after a same light source is used to emit light towards the half mirror device of Corn. Example 3 and Example 6 on the back side of the half mirror devices.

As shown in FIG. 6, it could be seen that Corn. Example 3 exhibits degraded aesthetic appearance due to the occurrence of a light-gathering or inhomogeneous lighting phenomenon such as paper-tearing, whereas Example 6 exhibits homogeneous lighting effect in the whole lighting area. Thus, it could be seen that upon implementing the hidden-type lighting, the light-transmitting holes are preferably provided in a regular pattern.

Although preferred embodiments of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A half mirror panel, comprising:
a light-transmitting base layer;
a mirror layer formed on a front surface of the base layer to reflect light, the mirror layer having a plurality of light-transmitting holes at regular intervals through opposite surfaces of the mirror layer in a thickness direction; and
a light-transmitting protective layer formed on a front surface of the mirror layer to protect the mirror layer.

2. The half mirror panel according to claim 1, wherein the mirror layer has a thickness of greater than or equal to 100 nm.

3. The half mirror panel according to claim 2, wherein the mirror layer has a thickness of less than or equal to 15 μm.

4. The half mirror panel according to claim 1, wherein the light-transmitting hole of the mirror layer has a diameter of 30 μm to 150 μm.

5. The half mirror panel according to claim 4, wherein the diameter of the light-transmitting hole is 55 μm to 80 μm.

6. The half mirror panel according to claim 1, wherein the light-transmitting hole of the mirror passes through the mirror layer from a back surface to the front surface of the mirror layer in a linear form.

7. The half mirror panel according to claim 1, wherein the light-transmitting holes of the mirror layer are spaced apart at equidistant intervals.

8. The half mirror panel according to claim 7, wherein the light-transmitting holes of the mirror layer are spaced apart from each other at intervals of 100 μm to 400 μm.

9. The half mirror panel according to claim 8, wherein the light-transmitting holes of the mirror layer are spaced apart from each other at intervals of 150 μm.

10. The half mirror panel according to claim 1, wherein the light-transmitting holes of the mirror layer are spaced apart at regularly-increasing or decreasing intervals in a first direction, and at equidistant intervals in a second direction perpendicular to the first direction.

11. The half mirror panel according to claim 1, wherein the front surface of the mirror layer is divided into a transmitting area and a non-transmitting area, wherein the light-transmitting holes are formed in the transmitting area.

12. The half mirror panel according to claim 1, wherein the base layer has a thickness of greater than or equal to 10 μm.

13. The half mirror panel according to claim 1, wherein the protective layer has a thickness of greater than or equal to 15 μm.

14. A half mirror device, comprising:
a panel; and
at least one light source disposed on a back side of the panel to emit light, the panel comprising:
a light-transmitting base layer;
a mirror layer formed on a front surface of the base layer to reflect light, the mirror layer having a plurality of light-transmitting holes at regular intervals through opposite surfaces of the mirror layer in a thickness direction; and
a light-transmitting protective layer formed on a front surface of the mirror layer to protect the mirror layer,
wherein the light source transmits light through the light-transmitting holes of the mirror layer.

15. The half mirror device according to claim 14, wherein a front surface of the panel is divided into a transmitting area and a non-transmitting area, wherein the light-transmitting holes of the mirror layer are formed in the transmitting area, and the light source is disposed on a back side of the transmitting area.
